(19) United States
(12) Patent Application Publication
(10) Pub. No.: US 2021/0387262 A1
(43) Pub. Date: Dec. 16, 2021

(54) PART PACKING BASED ON AGENT USAGE

(71) Applicant: Hewlett-Packard Development Company, L.P., Spring, TX (US)

(72) Inventors: Juan Carlos Catana Salazar, Guadalajara (MX); Ismael Femandez Aymerich, Sant Cugat del Valles (ES); David Ramirez Muela, Sant Cugat del Valles (ES); Jun Zeng, Palo Alto, CA (US)

(73) Assignee: Hewlett-Packard Development Company, L.P., Spring, TX (US)

(21) Appl. No.: 17/287,477

(22) PCT Filed: Dec. 11, 2018
(86) PCT No.: PCT/US2018/064916

§ 371 Date: Apr. 21, 2021

(51) Int. Cl. B22F 10/80; G05B 13/02; G05B 19/4093; B33Y 50/00

(52) U.S. Cl. CPC B22F 10/80; G05B 13/0265; G05B 2219/32333; B33Y 50/00; G05B 2219/49023; G05B 19/40931

(57) ABSTRACT

Examples of methods for part packing based on agent usage are described herein. In some examples, a method includes or methods include determining an agent usage for each of a plurality of packings. In some examples, the method includes or methods include selecting a packing from the plurality of packings based on the agent usages.

### BACKGROUND

Three-dimensional (3D) solid parts may be produced from a digital model using additive manufacturing. Additive manufacturing may be used in rapid prototyping, mold generation, mold master generation, and short-run manufacturing. Additive manufacturing involves the application of successive layers of build material. This is unlike some machining processes that often remove material to create the final part. In some additive manufacturing techniques, the build material may be cured or fused.

### BRIEF DESCRIPTION OF THE DRAWINGS

FIG. 1 is a flow diagram illustrating an example of a method for part packing based on agent usage;

FIG. 2 is a block diagram of an example of an apparatus that may be used in part packing based on agent usage;

FIG. 3 is a block diagram illustrating an example of a computer-readable medium for performing part packing based on agent usage;

FIG. 4 is a flow diagram illustrating an example of a method for part packing based on agent usage; and

FIG. 5 is a diagram illustrating an example of determining agent usage.

### DETAILED DESCRIPTION

Additive manufacturing may be used to manufacture three-dimensional (3D) parts. A part is an object that may be formed through additive manufacturing. 3D printing is an example of additive manufacturing. Performing additive manufacturing relies on a packing. A packing is information that specifies an arrangement (e.g., position, location, orientation, etc.) of parts in a build volume. A build volume is a 3D space. A build volume may correspond to a physical space in which additive manufacturing may be performed. It may be beneficial to increase packing density in the build volume to increase production and/or reduce manufacturing costs.

It may be beneficial to determine a packing based on thermal physics. Some of the techniques described herein address a “thermal-aware” aspect of packing. For example, approaches to packing (e.g., part selection for placement, parts orientation, and/or placement) may be performed to mitigate thermal management challenges in manufacturing (e.g., printing). For instance, part packing may be determined based on an objective, such as agent usage. Agent usage is an amount of an agent or agents used or anticipated to be used to manufacture a set of parts.

An agent is a substance used in some kinds of additive manufacturing. For example, an agent may modify the thermal behavior of material when exposed to energy. Some examples of 3D printing may selectively deposit agents (e.g., droplets) at a pixel level to enable control over voxel-level energy deposition. For instance, thermal energy may be projected over material in a build area, where a phase change and solidification in the material may occur depending on the voxels where the agents are deposited. Examples of agents include fusing agent, detailing agent, and binder agent. A fusing agent is an agent that causes material to fuse when exposed to energy. A detailing agent is an agent that prevents fusing. A binder agent is an agent that causes metal to bind.

It should be noted that while plastics may be utilized as a way to illustrate some of the approaches described herein, the techniques described herein may be applied to a variety of additive manufacturing techniques. Some additive manufacturing techniques may be powder-based and driven by powder fusion. Some additive manufacturing techniques may include metal printing, such as metal jet fusion. In some examples of metal printing, a binder agent may be utilized. Some examples of the approaches described herein may be applied to powder bed fusion-based additive manufacturing, such as Selective Laser Melting (SLM), Selective Laser Sintering (SLS), Multi-Jet Fusion (MJF), etc. Some examples of the approaches described herein may be applied to additive manufacturing where agents carried by droplets are utilized for voxel-level thermal modulation.

In some examples, part packing may be based on various objectives. An example of an objective is agent usage (e.g., reduce or minimize agent usage). For instance, one objective may be reducing or minimizing the usage of a detailing agent. Another example of an objective is packing density (e.g., increasing or maximizing packing density). Some examples of the techniques described herein may apply slice level operations (e.g., writing systems level operations) to analyze a set of parts (e.g., a batch) to guide part packing to be optimized for a writing system objective or objectives. An example of a writing system objective is reducing or minimizing the usage of detailing agent. A writing system is a device (e.g., printer, processor, electronic device, etc.) that plans and/or controls manufacturing. For example, a writing system may determine amounts and/or locations of agent distribution at a slice level.

A detailing agent or detailing agents may be used to provide a corrective measure for build areas that may receive an amount of thermal energy exceeding a target amount. In some examples, a total budget for detailing agent per voxel may be limited and/or may be a scarce writing systems resource. Detailing agent may be a scarce resource, since detailing agent may be one of a few writing systems tools that may be utilized to reduce thermal energy with voxel resolution. In some examples, the use of detailing agent may have a significant negative impact on print head nozzle health.

Some examples of the systems and methods disclosed herein may be beneficial by reducing or minimizing the amount of detailing agent used to manufacture parts. Reducing or minimizing detailing agent usage may improve part quality by providing more voxel-level cooling control. Reducing or minimizing detailing agent usage may improve a print head's lifespan and/or may reduce maintenance costs. Reducing or minimizing detailing agent usage may reduce the consumable costs (e.g., by consuming less detailing agent).

Throughout the drawings, identical or like reference numbers may designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

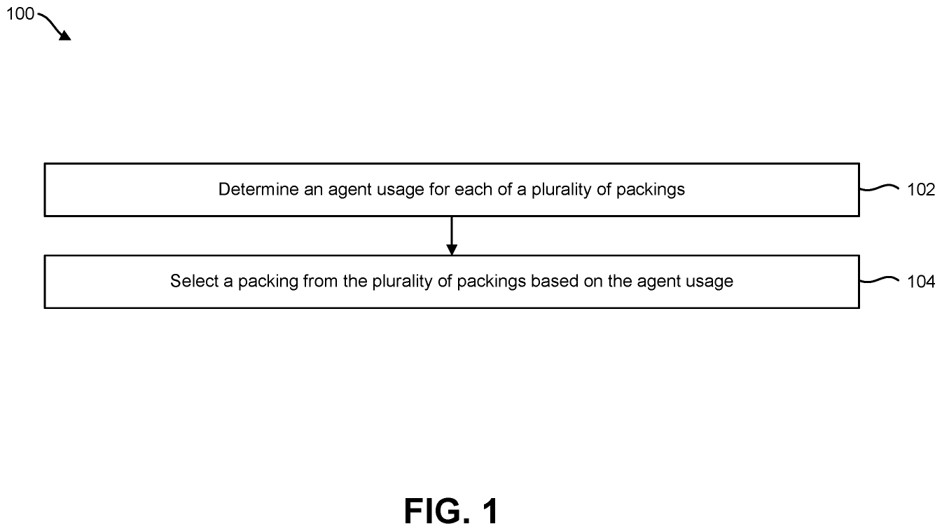

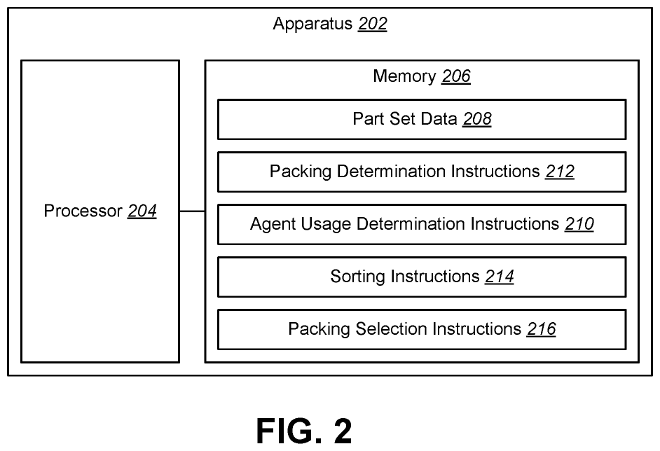

FIG. 1 is a flow diagram illustrating an example of a method 100 for part packing based on agent usage. The method 100 and/or a method 100 element or elements may be performed by an apparatus (e.g., electronic device). For example, the method 100 may be performed by the apparatus 202 described in connection with FIG. 2.

The apparatus may determine 102 an agent usage for each of a plurality of packings. Each of the agent usages indicates an amount of agent (e.g., detailing agent, fusing agent, and/or binding agent) to manufacture each of the plurality of packings, respectively. In some examples, the agent usage may be determined 102 based on a 3D model, packing, slices, and/or contone maps, etc. The packing, slices, and/or contone maps may be examples of writing systems level information. A slice is a set of data indicating a layer of a model or packing. A contone map is a set of data indicating a location or locations (e.g., areas) for printing a substance (e.g., fusing agent, detailing agent, or binder agent). A contone map may correspond to a slice or layer for manufacturing.

In some examples, determining 102 the agent usage for a packing may include slicing the packing to produce a set of slices. Each slice and/or a set of slices (e.g., a number of slices, a subset of slices of a packing, or all slices in a packing) may be scored in some examples. A score is a value (e.g., number) corresponding to a slice and/or packing. For example, a score may be utilized to evaluate a slice and/or packing. A re-amplification score is an example of the score that is based on re-amplification intensity. In some examples, the score may be a black density (e.g., black density score) or may be based on determining a black density and/or a black density score for a slice or slices (e.g., layer(s)). A black density is a ratio between a number of black (e.g., agent, ink, or part) voxels over a voxel bed size (e.g., total number of voxels) for a slice or layer. As used herein, the term “black” may refer to any pixel or voxel that includes an energy absorbing agent regardless of actual color (e.g., white, yellow, pink black, or any other color). A black density score is a value (e.g., number) that may be obtained by integrating a black density measured for each slice or layer.

In some examples, a re-amplification score may be a score that is determined by computing a re-amplification intensity map for each slice (e.g., layer). A kernel may be applied to each slice to produce a re-amplification intensity map of each slice. A kernel is a matrix or mask utilized to apply a transformation (e.g., convolution) on a slice, layer, or contone map. In some examples, the kernel may be smaller in size than the slice, layer, or contone map. For example, the apparatus may apply the kernel to each slice by convolving the kernel with each slice to produce the re-amplification intensity map of each slice. A re-amplification intensity map is a set of data indicating a thermal re-amplification intensity over an area (e.g., the slice, a set of pixels, etc.).

In some examples, a re-amplification score may be determined for each re-amplification intensity map. A re-amplification score is a value that indicates thermal re-amplification for a re-amplification map or slice. In some examples, determining the re-amplification score may be based on an integration (e.g., mathematical integral calculation, numerical integral calculation) over an area or areas of the re-amplification map or slice that correspond to a part or parts. For instance, the apparatus may integrate the re-amplification intensity map in two dimensions at positions (e.g., pixel locations) corresponding to a part or parts.

In some examples, determining the re-amplification score may be based on black density. For instance, the re-amplification intensity map may be integrated over a part area to produce a re-amplification value for each slice, and determining the re-amplification score may include dividing the re-amplification value by a black density for each slice.

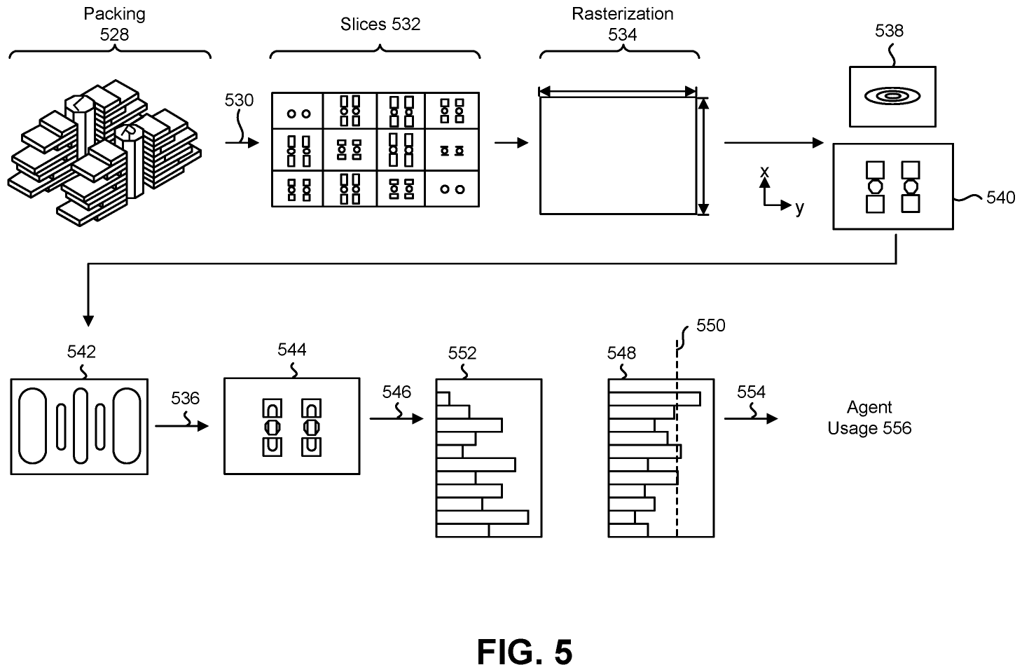

In some examples, determining 102 the agent usage may be based on the score (e.g., re-amplification score and/or black density score, etc.). For instance, a function or relationship may be utilized to calculate the agent usage based on the re-amplification score. For example, the re-amplification score may be directly correlated with the agent usage (e.g., detailing agent usage) that may be utilized to compensate for the re-amplification intensity. In some examples, the apparatus may calculate the agent usage of the packing based on the re-amplification scores. For example, a per-slice agent usage may be determined (e.g., calculated) based on the re-amplification score (corresponding to each slice or layer, for instance). In some examples, the per-slice agent usages may be combined (e.g., summed) to produce the agent usage (e.g., total agent usage) for the packing. An example of determining the agent usage is given in connection with FIG. 5.

The apparatus may select 104 a packing from the plurality of packings based on the agent usages. In some examples, selecting 104 the packing is based on a genetic algorithm with an objective to reduce agent usage. A genetic algorithm is a procedure (e.g., partial search procedure) to produce a solution to a search problem. A genetic algorithm may utilize an objective or objectives to produce a solution. In some examples, selecting 104 the packing may be based on a genetic algorithm with an objective to reduce agent usage.

In some examples, the apparatus may create a set of packings in a generation. A generation is a set of solutions (e.g., packings). For example, a generation may correspond to each iteration of the genetic algorithm. Creating a set of packings may include randomizing a chromosome or chromosomes. Chromosomes are attributes of a packing. Examples of chromosomes include part position, part location, and/or orientation for a number (e.g., set) of parts.

In some examples, the apparatus may sort the set of packings in the generation based on an objective or objectives. For example, the set of packings may be sorted based on agent usages, where lower agent usages are ranked better (e.g., higher) than higher agent usages.

In some examples, the apparatus may propagate chromosomes of a subset of the set of packings based on the sorting. For example, a number of the best packings (e.g., highest ranked) may be determined as the subset. Chromosomes corresponding to the packings in the subset may be propagated. For instance, chromosomes from the subset may be utilized to initialize chromosomes of a next generation. In some examples, chromosomes from the subset may be propagated to (e.g., inherited by) a next generation (e.g., a next set of packings).

In some examples, selecting 104 the packing may include selecting a packing of a last generation based on the agent usages. For instance, when the genetic algorithm has iterated for a number of generations, the apparatus may select a packing based on the agent usage as an objective. In some examples, the apparatus may select a packing with the least agent usage. In some examples, the apparatus may select packing based on the agent usage in combination with another objective (e.g., packing density). For instance, a packing with a best combination of objectives, such as agent usage and packing density, may be selected.

In some examples, the packing may be executed to manufacture the parts. For example, the parts may be manufactured by an apparatus (e.g., 3D printer) in accordance with the selected packing. For instance, an apparatus may send the packing to another device (e.g., 3D printer) or may execute the packing to manufacture the parts in the packing. It should be noted that some examples of the techniques described herein may be utilized in a variety of additive manufacturing. Some additive manufacturing techniques may be powder-based and driven by powder fusion. Some additive manufacturing techniques may include metal printing, such as metal jet fusion. Some examples of the approaches described herein may be utilized in powder bed fusion-based additive manufacturing, such as Selective Laser Melting (SLM), Selective Laser Sintering (SLS), Multi-Jet Fusion (MJF), etc.

FIG. 2 is a block diagram of an example of an apparatus 202 that may be used in part packing based on agent usage. The apparatus 202 may be an electronic device, such as a personal computer, a server computer, a printer, a 3D printer, a smartphone, a tablet computer, etc. The apparatus 202 may include and/or may be coupled to a processor 204 and/or a memory 206. In some examples, the apparatus 202 may be in communication with (e.g., coupled to, have a communication link with) an additive manufacturing device (e.g., a 3D printing device). Alternatively, the apparatus 202 may be an example of a 3D printing device. The apparatus 202 may include additional components (not shown) and/or some of the components described herein may be removed and/or modified without departing from the scope of this disclosure.

The processor 204 may be any of a central processing unit (CPU), a semiconductor-based microprocessor, graphics processing unit (GPU), field-programmable gate array (FPGA), an application-specific integrated circuit (ASIC), and/or other hardware device suitable for retrieval and execution of instructions stored in the memory 206. The processor 204 may fetch, decode, and/or execute instructions (e.g., packing determination instructions 212, agent usage determination instructions 210, sorting instructions 214, and/or packing selection instructions 216) stored in the memory 206. Additionally or alternatively, the processor 204 may include an electronic circuit or circuits that include electronic components for performing a function or functions of the instructions (e.g., packing determination instructions 212, agent usage determination instructions 210, sorting instructions 214, and/or packing selection instructions 216). In some examples, the processor 204 may be configured to perform one, some, or all of the functions, operations, elements, methods, etc., described in connection with one, some, or all of FIGS. 1-5.

The memory 206 may be any electronic, magnetic, optical, or other physical storage device that contains or stores electronic information (e.g., instructions and/or data). The memory 206 may be, for example, Random Access Memory (RAM), Electrically Erasable Programmable Read-Only Memory (EEPROM), a storage device, an optical disc, and the like. In some examples, the memory 206 may be volatile and/or non-volatile memory, such as Dynamic Random Access Memory (DRAM), EEPROM, magnetoresistive random-access memory (MRAM), phase change RAM (PCRAM), memristor, flash memory, and the like. In some implementations, the memory 206 may be a non-transitory tangible machine-readable storage medium, where the term “non-transitory” does not encompass transitory propagating signals. In some examples, the memory 206 may include multiple devices (e.g., a RAM card and a solid-state drive (SSD)).

In some examples, the apparatus 202 may include an input/output interface (not shown in FIG. 2) through which the processor 204 may communicate with an external device or devices (not shown), for instance, to receive and store information (e.g., part set data 208) pertaining to an object or objects to be manufactured (e.g., printed). The input/output interface may include hardware and/or machine-readable instructions to enable the processor 204 to communicate with the external device or devices. The input/output interface may enable a wired or wireless connection to the external device or devices. The input/output interface may further include a network interface card and/or may also include hardware and/or machine-readable instructions to enable the processor 204 to communicate with various input and/or output devices, such as a keyboard, a mouse, a display, another apparatus, electronic device, computing device, etc., through which a user may input instructions into the apparatus 202.

In some examples, the memory 206 may store part set data 208. The part set data 208 may be obtained (e.g., received) from an external device and/or may be generated on the apparatus 202. For example, the processor 204 may execute instructions (not shown in FIG. 2) to receive the part set data 208 from an external device.

The part set data 208 may include data indicating a number of parts and shapes (e.g., 3D models, dimensions, etc.) of parts. For example, the parts set data 208 may indicate a set of parts for packing and/or manufacture.

In some examples, the processor 204 may execute the packing determination instructions 212 to determine a set of packings in a population based on part set data 208. For example, the processor 204 may execute a genetic algorithm to determine the set of packings. In some examples, determining the set of packings may include randomizing chromosomes and/or propagating (e.g., inheriting) chromosomes. For instance, the processor 204 may randomize part placements (e.g., position, location, and/or orientation) in a build volume.

In some examples, the processor 204 may execute agent usage determination instructions 210 to determine an agent usage for each packing in the set of packings. For example, the processor 204 may, for each packing, determine a re-amplification score for slices and determine an agent usage based on the re-amplification scores. For instance, determining the agent usage may be accomplished as described in connection with FIGS. 1 and/or 5.

In some examples, the processor 204 may execute the sorting instructions 214 to sort the set of packings based on the agent usages. For instance, the set of packings may be sorted such that reduced agent usage is prioritized (e.g., lower agent usage ranks higher). In some examples, other approaches may be utilized to determine a packing with a lowest agent usage or to determine a plurality of packings with lowest agent usages in the set of packings. In some examples, density and agent usage may be balanced while not sorting based on agent usage.

In some examples, the processor 204 may execute the packing selection instructions 216 select a packing from a plurality of packings that is based on the set of packings. For example, the processor 204 may determine the set of packings, determine the agent usages, and/or sort the set of packings for a number of generations. The processor 204 may select the packing from a plurality of packings corresponding to the last generation.

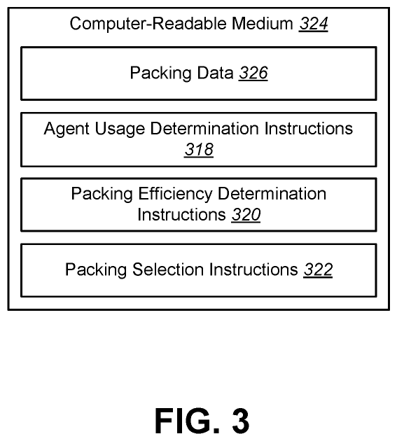

FIG. 3 is a block diagram illustrating an example of a computer-readable medium 324 for performing part packing based on agent usage. The computer-readable medium is a non-transitory, tangible computer-readable medium 324. The computer-readable medium 324 may be, for example, RAM, EEPROM, a storage device, an optical disc, and the like. In some examples, the computer-readable medium 324 may be volatile and/or non-volatile memory, such as DRAM, EEPROM, MRAM, PCRAM, memristor, flash memory, and the like. In some implementations, the memory 206 described in connection with FIG. 2 may be an example of the computer-readable medium 324 described in connection with FIG. 3.

The computer-readable medium 324 may include code (e.g., data and/or instructions). For example, the computer-readable medium 324 may include packing data 326, agent usage determination instructions 318, packing efficiency determination instructions 320, and/or packing selection instructions 322.

The packing data 326 may include information indicating a plurality of packings. For example, the packing data 326 may indicate a set of packings, a group of packings, a population of packings, and/or generations of packings. For instance, operations may be performed as described herein to determine a plurality of packings.

In some examples, the agent usage determination instructions 318 are code to cause a processor to determine an agent usage for each of a plurality of packings. For example, the processor may execute the agent usage determination instructions 318 to determine an amount of agent (e.g., detailing agent, fusing agent, binding agent) anticipated to be used in manufacturing the parts of the packings. In some examples, the agent determination instructions 318 may cause a processor to determine the agent usage as described in connection with one or more of FIGS. 1-2 and 4-5.

In some examples, the packing efficiency determination instructions 320 are code to cause the processor to determine a packing efficiency for each of the plurality of packings. A packing efficiency is a measure of an amount of packing relative to a volume. Examples of packing efficiency include packing density and/or packing height. For example, the processor may execute the packing efficiency determination instructions 320 to determine packing density and/or packing height for each of the plurality of packings. Packing density may be calculated as a ratio of volume of the parts in the packing to the volume of the build volume. Packing height may be calculated as a maximum height of a part or parts in the build volume for a packing. In some examples, the packing efficiency may include packing density, packing height, and/or a combination value of packing density and packing height.

In some examples, the packing selection instructions 322 are code to cause the processor to select a packing from the plurality of packings based on the packing efficiencies and the agent usages. For instance, the packing selection instructions 322 may cause a processor to determine a best packing in terms of a combination of the packing efficiency and agent usage. In some examples, the packing selection instructions 322 may cause a processor to determine a packing score based on a combination of the packing efficiency and agent usage for each packing. The packing with the best (e.g., greatest or highest) packing score may be selected.

In order to select a packing, the packing scores may compared. An example of packing selection is given as follows. Assume two packings A and B with corresponding packing scores s_A and s_B. In some examples, a packing score s_X may include a number of parameters (e.g., k parameters or fitness measures): s_X={p1_X, p2_X, . . . , pk_X}, where px_X is a parameter or fitness measure. A number (e.g., k) of threshold values may be utilized: α, β, . . . , φ. If the first k−1 parameters of each packing are relatively closer to each other (up to a configurable threshold), a Boolean value of (p1_A>p1_B) may indicate whether s_A is greater than s_B. For instance, In a case that abs(p1_A−p1_B) <α and abs(p2_A−p2_B)<β and so on for the rest of the parameters, and (pk_A !=pk_B), then a Boolean value of (pk_A>pk_B) may indicate whether s_A is greater than s_B. Otherwise, a parameter number k−1 may be compared. For instance, in a case that abs(p1_A−p1_B)<α and abs(p2_A−p2_B)<β and so on for the rest of the parameters, and (pk-1_A !=pk-1_B), then a Boolean value of (pk-1_A>pk-1_B) may indicate whether s_A is greater than s_B. Otherwise, similar comparisons may be made for a parameter or parameters (e.g., pk-2_A !=pk-2_B and so on) until the final case, where (p1_A>p1_B) may indicate whether s_A is greater than s_B. The packing with the greatest score may be selected. It should be noted that one parameter or multiple parameters may be utilized in the comparison.

In some examples, the computer-readable medium 324 may include code for causing a processor to manufacture the selected packing. For example, the code may cause a processor to execute instructions and/or send instructions to another device (e.g., 3D printer) to manufacture the selected packing.

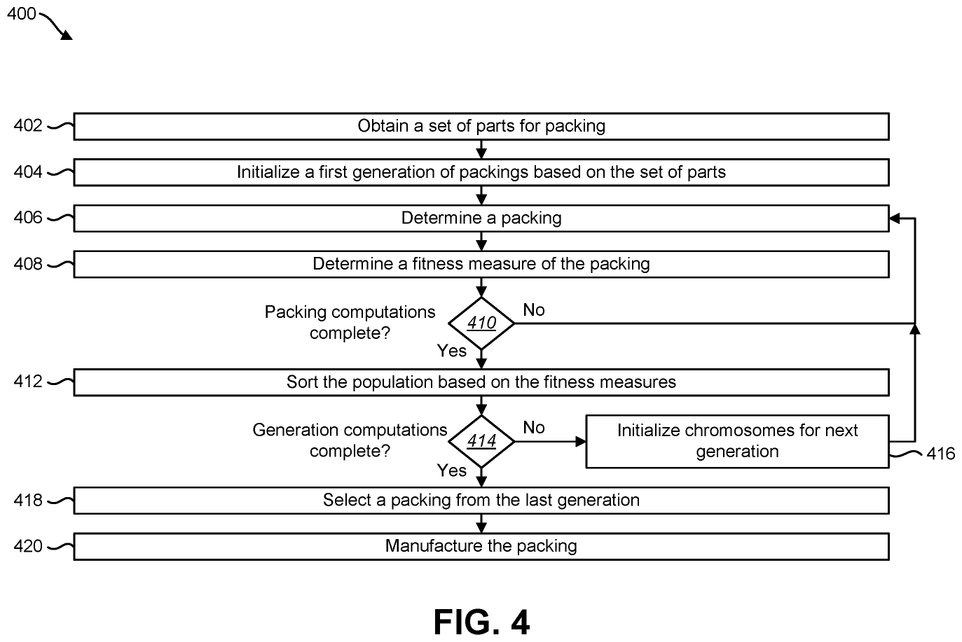

FIG. 4 is a flow diagram illustrating an example of a method 400 for part packing based on agent usage. In some examples, the method 400 may be an example of the method 100 described in connection with FIG. 1. In some examples, the method 400 may be performed by an apparatus (e.g., the apparatus 202 described in connection with FIG. 2). In some examples, the operations or functions described in connection with the method 400 may be encoded as data and/or instructions and stored on a computer-readable medium (e.g., the computer-readable medium 324 described in connection with FIG. 3). In some examples, some of the operations or functions described in connection with FIG. 4 may be performed as part of genetic algorithm for parts packing. For instance, a genetic algorithm may be utilized to perform multi-objective optimization to determine a part packing.

The apparatus may obtain 402 a set of parts for packing. For example, the apparatus may receive the part set data from another device and/or may generate part set data. In some examples, the part set data may include pre-packed parts, a part list and/or parts with orientation constraints.

The apparatus may initialize 404 a first generation of packings based on the set of parts. For example, the apparatus may randomize the chromosomes (e.g., some or all of the chromosomes) of the set of parts. In some examples, the apparatus may prepare part orientations according to the orientation constraints. For example, the part orientations may be limited to the orientation constraints in some approaches. The apparatus may create multiple (e.g., N) generations as follows.

The apparatus may determine 406 a packing. For example, the apparatus may create a packing. In some approaches, the packing may be created based on orientation constraints.

The apparatus may determine 408 a fitness measure of the packing. A fitness measure is a measure that indicates a degree to which the packing satisfies an objective or objectives (e.g., maximizing packing density, minimizing packing height, minimizing agent usage, etc.). For example, the fitness measure may be evaluated for each packing (e.g., instance of a packing solution). Examples of fitness measures may include packing density, packing height (e.g., z-height) and/or agent usage (e.g., total detailing agent usage). In some examples, the fitness measure may be agent usage or may be based on agent usage. The fitness measure may be based on writing system information (e.g., slices, contone maps, etc.). A fitness measure may be utilized to discriminate one packing over another packing. In some examples, a group of fitness measures or parameters may be assembled to form a packing score that can be utilized to discriminate one packing over another packing.

The apparatus may determine 410 whether packing computations are complete. For example, the apparatus may utilize a generation size value. The generation size value is a threshold number of packings in a generation. The generation size value may be predetermined. In a case that the packing computations are not complete (e.g., if the number of packings determined with fitness measures is less than the generation size value), the apparatus may return to determine 406 another packing and determine 408 another fitness measure. This procedure may be repeated until the generation size value or threshold is satisfied.

In a case that the packing computations are complete, the apparatus may sort 412 the population based on the fitness measures. For example, the apparatus may sort 412 the population in an order that prioritizes better fitness measures (e.g., in ascending order where lower fitness measures are better).

The apparatus may determine 414 whether generation computations are complete. For example, the apparatus may utilize a generations threshold. The generations threshold is a target number of generations. The generations threshold may be predetermined.

In a case that the generation computations are not complete (e.g., if the number of generations determined is less than the generations threshold), the apparatus may initialize 416 chromosomes for a next generation. In some examples, initializing 416 chromosomes for a next generation may include propagating chromosomes from a subset of the (e.g., the n best) packings in the current generation. For instance, the chromosomes may be inherited for the next generation initialization. In some examples, initializing 416 chromosomes for a next generation may include creating a number (e.g., n) chromosomes by crossing over genes from the subset of the (e.g., the n best) packings. In some examples, initializing 416 chromosomes for a next generation may include creating a number (e.g., n) chromosomes by randomizing some genes (e.g., mutating). In some examples, initializing 416 chromosomes for a next generation may include randomizing remaining chromosomes (e.g., other chromosomes that are not created from the subset of packings in the current generation). The apparatus may return to determine 406 another packing for the generation and determine 408 another fitness measure. This procedure may be repeated until the generations threshold is satisfied.

In a case that the generation computations are complete, the apparatus may select 418 a packing from the last generation. For example, the apparatus may select 418 a packing from the last generation that has the best fitness measure. In some cases, the apparatus may manufacture 420 the packing. For example, the apparatus may execute the packing to manufacture 420 the packing and/or may send the packing to another device (e.g., a 3D printer) to manufacture the packing.

FIG. 5 is a diagram illustrating an example of determining agent usage. It should be noted that while the example of FIG. 5 is given, other approaches may be implemented to determine a fitness measure and/or agent usage. In particular, FIG. 5 shows an example of a computing flow of applying writing systems logic to evaluate the fitness measure of a packing for an objective. Examples of objectives may include a total agent usage (for multiple agents, for instance), a total agent usage (of a detailing agent, for instance), an agent usage (e.g., detailing agent consumption) due to a compensation cause (e.g., re-amplification), and/or other writing systems objectives.

As illustrated in the example of FIG. 5, a packing 528 may be sliced 530 to produce slices 532 (e.g., vector slices). For example, the slices 532 may be expressed as Scalable Vector Graphics (SVG) data and/or file(s). Rasterization 534 may be performed for each of the slices 532 to produce rasterized slices 540. A rasterized slice 540 is a rasterized image corresponding to a slice 532. In some examples, the rasterized slices 540 may have a pixel density (e.g., pixels per inch (ppi)) tuned to kernel 538 (e.g., re-amplification kernel) application. For example, the pixel density may vary over the bed size. In other examples, the pixel density may be uniform. Examples of rasterized slices 540 include Portable Network Graphics (PNG) data and/or file(s) (e.g., 8-bit images).

The kernel 538 (e.g., firmware kernel) may be applied to each of the rasterized slices 540 to produce a re-amplification intensity map 542 corresponding to each slice 532 or rasterized slice 540. For example, applying the kernel 538 to each of the rasterized slices 540 may include convolving the kernel 538 with each of the rasterized slices 540 (e.g., layers). For instance, the re-amplification intensity map 542 may indicate a re-amplification intensity for each pixel of each the slices 532 (e.g., rasterized slices 540). In some examples, the re-amplification intensity map 542 may be filtered 536 to produce a filtered re-amplification intensity map 544. For example, a score for a slice or layer may be computed based on a certain portion or portions (e.g., portion(s) corresponding to part(s)) of the slice or layer, where regions with no valuable data may be discarded. For instance, the filtered re-amplification intensity map 544 may be an example of a filtered image that includes data that may be considered to compute a score for a slice or layer. The re-amplification intensity map 542 and the filtered re-amplification intensity map 544 are examples of a writing systems field value. It should be noted that other kernels may be applied to determine other writing systems field values that may be utilized in addition to or alternatively from the re-amplification intensity map 542.

In some examples, a per-pixel writing systems field value map may be processed to produce a per-slice score. For example, re-amplification scores 548 may be determined based on the re-amplification intensity maps 542 and/or the filtered re-amplification intensity maps 544. For instance, the re-amplification intensity map 542 or filtered re-amplification intensity map 544 may be integrated 546 to produce a re-amplification value for each slice in accordance with Equation (1).

$${Value}_{RA} = {\int }_{x} {\int }_{y} RA dx dy \\ for x , y ∈ P \qquad ( 1 )$$

In Equation (1), Value is the re-amplification value for a slice (e.g., for a part or parts of a slice), x is a horizontal dimension (e.g., horizontal pixel index), y is a vertical dimension (e.g., vertical pixel index), RA is the re-amplification intensity map or filtered re-amplification intensity map, and P is a part area or areas of the re-amplification intensity map or filtered re-amplification intensity map. The re-amplification values may be divided by black density 552 for each slice to determine the re-amplification scores 548. In FIG. 5, the black densities 552 in the horizontal dimension are illustrated for sets of slices in the vertical dimension of the plot. In FIG. 5, the re-amplification scores 548 in the horizontal dimension are illustrated for sets of slices in the vertical dimension of the plot. A re-amplification threshold 550 is also illustrated. For those slices in which the re-amplification scores exceed the re-amplification threshold 550, detailing agent may be applied to reduce re-amplification intensity.

In some examples, the agent usage 556 of a packing may be calculated 554 based on the re-amplification scores 548. For example, the per-slice re-amplification scores may be assembled into an agent usage 556, which can be used as a fitness measure for a writing systems objective. In some examples, calculating 554 the agent usage 556 may include determining a per-slice agent usage based on the re-amplification score 540 for each slice and summing the per-slice agent usage to produce the agent usage 556 (e.g., total agent usage) for a packing.

In some examples, the procedure described in connection with FIG. 5 may be utilized in an example where the writing systems objective is a total detailing agent compensation for re-amplification. The kernel 538 may be applied for each rasterized slice 536 for a convolution operation to generate per-pixel re-amplification intensity, which may be further processed into per-slice re-amplification score 548 weighed by black density 552. The re-amplification score may be directly correlated with a total amount of detailing agent used to compensate the re-amplification intensity. By summing up over all slices, the agent usage 556 for the packing may be determined. Similar procedures may be utilized for other writing systems metrics in addition to or alternatively from the agent usage 556.

In some examples, for a given packing, the procedure described in connection with FIG. 5 may be performed, and a writing systems metric may be computed (e.g., total agent usage 556). A packing may be selected over others for a writing systems objective (e.g., minimizing total agent usage). In some examples, reducing agent usage 556 may be combined with increasing packing density to optimize part packing for a writing systems objective.

Some examples of the techniques described herein may be beneficial for the following reasons. In some examples (e.g., MJF), detailing agent may be utilized to perform voxel-level cooling. Detailing agent may be used as a thermal energy corrective function. For instance, detailing agent may be utilized for part boundaries, clearing holes, small surfaces, upper surfaces of parts, and even part interiors. Reducing detailing agent usage may be beneficial for multiple reasons. For example, there may be a finite budget for detailing agent for a given voxel. Detailing agent may be employed in multiple use cases. Accordingly, conserving detailing agent may be beneficial. Excessive use of detailing agent may have negative impacts to part quality.

Using detailing agent may have a negative impact to print head health, which may increase maintenance and/or consumable costs. In some examples, in a two-pass print mode, the print head may be exposed to fresh powder at approximately 160 degrees Celsius (C) when printing fusing agent on a first pass, and to powder at approximately 180-190 C when printing fusing agent on a second pass. However, when printing detailing agent, the print head may be exposed to powders with elevated temperatures as hot as 220 C-230 C. Accordingly, some examples of the systems and methods disclosed herein may be utilized to reduce detailing agent usage, which may preserve print head health, reduce consumable costs, and/or reduce maintenance costs.

1. A method, comprising:
determining an agent usage for each of a plurality of packings; and
selecting a packing from the plurality of packings based on the agent usages.

2. The method of claim 1, wherein the agent usages indicate an amount of detailing agent to manufacture each of the plurality of packings.

3. The method of claim 1, wherein determining the agent usage for a first packing of the plurality of packings comprises:
slicing the first packing to produce a set of slices;
applying a kernel to each slice of the set of slices to produce a re-amplification intensity map of each slice;
determining a re-amplification score for each re-amplification intensity map; and
calculating the agent usage of the packing based on the re-amplification score.

4. The method of claim 3, wherein applying the kernel to each slice comprises convolving the kernel with each slice.

5. The method of claim 3, further comprising integrating the re-amplification intensity map over a part area to produce a re-amplification value for each slice, and wherein determining the re-amplification score comprises dividing the re-amplification value by a black density for each slice.

6. The method of claim 3, wherein calculating the agent usage comprises:
determining a per-slice agent usage based on the re-amplification score for each slice; and
summing the per-slice agent usages to produce the agent usage.

7. The method of claim 3, wherein the calculating the agent usage is based on a direct correlation between the agent usage and the re-amplification score.

8. The method of claim 1, wherein selecting the packing is based on a genetic algorithm with an objective to reduce agent usage.

9. The method of claim 1, further comprising, for a number of generations:
creating a set of packings in a generation;
sorting the set of packings in the generation based on the agent usages; and
propagating chromosomes of a subset of the set of packings based on the sorting.

10. The method of claim 9, wherein selecting the packing comprises selecting one packing of a last generation based on the agent usages.

11. An apparatus, comprising:
a memory;
a processor coupled to the memory, wherein the processor is to:
determine a set of packings in a population based on part set data;
determine an agent usage for each packing of the set of packings; and
select a packing from a plurality of packings that is based on the set of packings.

12. The apparatus of claim 11, wherein the processor is to determine the set of packings and determine the agent usage for a plurality of generations.

13. The apparatus of claim 12, wherein the processor is to select the packing from a last generation of the plurality of generations.

14. A non-transitory tangible computer-readable medium storing executable code, comprising:
code to cause a processor to determine an agent usage for each of a plurality of packings;
code to cause the processor to determine a packing efficiency for each of the plurality of packings; and
code to cause the processor to select a packing from the plurality of packings based on the packing efficiencies and the agent usages.

15. The computer-readable medium of claim 14, further comprising code to cause the processor to manufacture the packing.
